(19) United States
(12) Patent Application Publication
(10) Pub. No.: US 2010/0126319 A1
(43) Pub. Date: May 27, 2010

(54) CUTTING DEVICE AND CUTTING METHOD FOR PRINTED PRODUCTS

(75) Inventor: Carl Conrad Mäder, Hinwil (CH)

Correspondence Address: PAULEY PETERSEN & ERICKSON, 2800 WEST HIGGINS ROAD, SUITE 365, HOFFMAN ESTATES, IL, 60169, US

(73) Assignee: Ferag AG, Hinwil (CH)

(21) Appl. No.: 12/452,002

(22) PCT Filed: Mar. 11, 2008
(86) PCT No.: PCT/CH2008/000104

§ 371 Date: Dec. 11, 2009

(30) Foreign Application Priority Data
Jun. 15, 2007 (CH) 968/07

(51) Int. Cl. B26D 1/20; B26D 7/12; B26D 1/22

(52) U.S. Cl. 83/13; 83/174; 83/401; 83/508

(57) ABSTRACT

The invention relates to a cutting device for cutting continuously conveyed printed products (5). The cutting device has multiple conveying elements (3) which run around a closed path for conveying at least one single printed product (5) or printed product groups (5′). The printed products (5, 5′) are moved along their conveyance path past at least one cutting station (10). In each cutting station, at least one edge of the printed product (5) is cut by knife blades (11, 12) and counter blades (13, 14) in a shear cut. For this shear cut, according to the invention, multiple self-sharpening blades (11, 12) come into cutting engagement with at least one counter blade (13, 14). Alternatively, multiple counter blades (13, 14) come into cutting engagement with at least one self-sharpening blade (11, 12). A significant improvement in edge retention and cutting quality is achieved by means of targeted blade kinematics, blade arrangement, product guidance, and blade geometry.

### BACKGROUND OF THE INVENTION

1. Field of the Invention

The present invention relates to a cutting apparatus and to a cutting method.

2. Discussion of Related Art

Multilayered printed products, e.g. periodicals, newspapers or booklets, are usually trimmed nowadays along one or more sides. In this respect, the prior art discloses various solutions which differ by way of cutting capacity, cutting quality and various other parameters. The task of a person skilled in the art here is to determine a particular cutting method depending on requirements such as, in particular, the kind of products which are to be trimmed (type of paper, weight, thickness, page count of the product, folded or glued, printing method, etc.).

Alongside so-called rotary cutting devices, as are known for example from EP 0 017 878, so-called cutting drums, which have been disclosed in the present applicant's EP 0 367 715, have proven successful in practice in recent years. In the case of rotary cutters, the printed products, conveyed in the form of an imbricated stream (scaled stream), are moved past a cutting station, but usually two or three cutting stations, as they lie on a conveying belt. Each of these cutting stations has a rotating cutting knife which interacts with a usually likewise rotating counter-knife. Such a cutting method, in which knives and counter-knives interact, and come into cutting engagement, for trimming purposes, is referred to in specialist circles as shear cutting or two-knife cutting. The knives and counter-knives in rotary cutters are rigidly assigned to one another within a cutting station and, during operation, act together permanently in pairs.

Shear cutting is also used in the case of the abovementioned cutting drums. A significant difference in this case, however, resides in the fact that, rather than being conveyed in an imbricated stream (scaled stream), the printed products are conveyed individually or in groups located one above the other and the knives and counter-knives—contrary to the case of rotary cutters—are not constantly assigned to one another. For this purpose, each printed product moving in the cutting drum is temporarily assigned a first knife part, which is brought into abutment with the printed product, a plurality of such first knife parts being provided. The respective side edge is trimmed by virtue of these first knife parts coming into cutting engagement with a second, usually fixed-location knife part. Cutting drums which have proven successful in practice thus nowadays use, for trimming the side edges of the printed product, a plurality of first counter-knives which interact with a single, fixed-location knife. It is, of course, possible, as disclosed in EP 0 367 715, for only a small number of first knives, or a multiplicity of first knives, to be assigned to the second knife. Provision thus may be made, for example, for forty first counter-knives, or even just four first counter-knives, to interact with a second knife, etc.

A person skilled in the art is aware that with the same cutting principle, namely a shear-cutting method, the issues of knife quality and cutting accuracy and of service life of the knives in cutting drums, on account of paired interaction of knife and counter-knife, are subject to additional problems. It should be noted here that, in the printing industry, the cutting devices and the knives thereof have to meet specific requirements since not only are there very large numbers of products needing to be cut, but also extremely high cutting capacities are required.

Modern printer machines allow production capacities of more than 100,000 copies per hour. Daily print runs of a newspaper may comprise 300,000 or more copies per day. Product thicknesses nowadays of up to 12 or 15 mm are not infrequent, in which case a person skilled in the art also comes up against problems in this regard, for example control and introduction of cutting forces, stability-related requirements to be met by product guidance and clamping pressure and also knife retention. If we assume further increases in capacity in the next few years, then it can be seen that cutting machines have to have a daily capacity of significantly more than 100,000 copies/hour over a number of hours. Accordingly, cutting methods of this type are subject to problems and requirements which are fundamentally different from those of static cutting methods, as are known, for example, from hand shears or straightforward paper-cutting machines. A further special feature of the cutting methods used in finishing work, in addition, resides in the fact that the cutting operation should, or has to, take place while the products are flowing, that is to say in motion. As far as the processing capacities mentioned are concerned, stop-and-go processes (stopping and reacceleration of the products) are downright disadvantageous, in which case a so-called dynamic cutting process is sought. This is associated with problems relating to product stability, positioning precision of the products during cutting, jarring and vibration of the cutting devices and transporting means for the products, absorption of the cutting forces by transporting and cutting devices in the dynamic process, etc.

The wear and damage of the knives, and the service life of the latter, are becoming increasingly important. The significance of two different kinds of service life should be noted here: a distinction should be made between the time in use, i.e. the possible duration of interruption-free operation, e.g. for a product run, and the overall service life of the knife, i.e. the maximum number of cuts per knife as a result of the wear to the cutting edge of the tool, this also being referred to as edge retention. Added to this is the risk of undesired wear, e.g. as a result of product errors, statistical error rates, operational errors, etc., which are ascertained by the risk of failure within the context of the so-called MTBF (mean time between failure).

### SUMMARY OF THE INVENTION

The present invention deals with the complex problems of cutting quality and knife service lives in high-performance systems using the shear-cutting method.

EP 1 510 288 discloses a special grinding method and a rotary cutting apparatus which aim to improve the problem of knife wear and service life. For this purpose, this document envisages that one of the two knives (usually the counter-knife or the so-called lower knife) is removed and replaced by a grinding disk, which is intended to grind the knives which have not been removed. Following the grinding operation, the grinding disk is replaced again by the knife. Overall, the intention here is to improve the down time of the machine, which usually lasts 10 to 30 minutes, and the resulting knife precision.

The above document explains that it is a particular problem of shear cutting that the cutting principle requires a very small and highly precise so-called cutting clearance. The cutting clearance between knife and counter-knife has a direct influence on the cutting quality and is dependent on the type of material which is to be cut. In the case of printed products which comprise a number of layers of paper, this cutting clearance, to provide good-quality cutting, has to be considerably less than the paper thickness and is therefore in the micrometer range. Depending on the paper quality, it is possible, as explained in EP 1 510 288, for the cutting clearance to be, for example, 0.03 to 0.035 mm (=30 to 35 μm). In many cases, for example for cutting newspapers, however, a considerably smaller cutting clearance of 12 to 15 μm is required.

This method, rather than being able to have a relevant positive influence on the time in use and overall service life of the blades, deals only with optimizing the down times of the installation. A further disadvantage is the fact that the abrasive regrinding of the knives takes place in the cutting station itself and therefore abrasive residues, grinding material and very small hard-metal filings remain in the cutting subassembly and thus increase the risk of damage to, and failure of, the cutting device. Overall, the method described in EP 1 510 288, and the rotary cutting machine claimed therein is not able to overcome the actual problem; rather, in the manner of controlling symptoms, only a single aspect of the maintenance problem is tackled.

A further shear-cutting method, which is done using a rotary cutting apparatus (rotary trimmer) and deals with the problems of cutting quality and wear to the knives, is described in EP 1 283 094. The apparatus disclosed there is a classic rotary cutter with two cutting stations which are arranged one after the other at an angle of 90° in relation to one another. One cutting station serves for so-called head and foot trimming, and the other cutting station serves for trimming the front or the two other side edges of the printed product. The document mentioned above aims to increase the edge retention by way of a regulating system which is intended to influence the cutting clearance in respect of adjustment and thermal effects. The corresponding solution is comparatively complex and is able to bring about only gradual improvements.

DE 36 07 907 deals with the problem of avoiding, as far as possible, the operation of regrinding a cutting tool. This document describes a cutting tool with two cutting edges which are in paired cutting engagement with one another. Accordingly, the document deals only with the broad basic concept of a self-sharpening effect and preferably provides for hardening of that surface of each knife which is inclined in relation to the cutting direction. The arrangement of the hardened layer which is provided in this document is unsuitable for cutting paper and results in a comparatively poor cutting quality and in frequent readjustment of the cutting clearance being required. The arrangement of the knives in relation to one another and the hardening of those surfaces of both the knife and counter-knife which are inclined in relation to the cutting direction means that this solution according to DE 36 07 907 is unsuitable for the high-performance cutting of printed products.

Furthermore, DE 24 29 814 discloses a self-sharpening cutting edge for so-called single-blade cutting (a single blade cutting against an underlying surface, referred to in DE 24 29 814 as “support”). In a manner similar to DE 36 07 907, mentioned above, here just a side surface of the knife is provided with a thin firmly adhering hard layer, while the cutting edge itself consists of softer material. That design has also remained unused in the industrial sector since the general teaching of this document, although a reduction in maintenance outlay could be expected, is not able to improve the cutting quality itself.

A further document, namely DE 10 2004 052 682 A1, likewise deals with the principle of a self-sharpening cutting tool which is suitable expressly just for mills. It is clear from DE 10 2004 052 682 that a knife-self-sharpening principle has to be adapted to the specific applications in each case since, depending on the application, the knife and cutting principle have to meet very different requirements. Particularly critical, in conjunction with mills, is the arrangement relative to one another of a cutting-rotor arrangement in conjunction with a stator knife and, in particular, the specific geometrical configuration of the cutting body of the cutting-rotor arrangement. The outwardly oriented surface of the cutting rotor is coated and curved.

The method in the above document relates to a tool for a grinding process, but not to the precise cutting or trimming of paper. It has been found that precisely this design of a cutting tool is disadvantageous for the high-performance cutting of printed products. On the one hand the cutting rotor and stator knives cannot be assigned to one another in the manner described above; on the other hand the curved cutting-rotor arrangement disclosed in the above document, the radius of curvature corresponding to the radius from the rotor center to the knife outer edge, is unsuitable for cutting printed products since the missing so-called angle of inclination of the knife brings with it the risk of paper being crumpled or even becoming jammed.

It is an object of the present invention to provide a cutting apparatus and a cutting method with a knife arrangement which is intended for the high-performance shear cutting of printed products and results in a better cutting quality and, at the same time, in the time in use and service life, or the edge retention, of the knives or of the knife being extended.

This object is achieved by the characterizing part of independent claims 1 and 10.

The concept of the invention is based on utilizing the long-known self-sharpening effect of knives by way of a special knife/counter-knife arrangement and configuration of a cutting knife for the paper industry, wherein specific knife kinematics, knife arrangement, product guidance and knife geometry bring about not just a significant improvement in the edge retention, but also a considerable improvement in the cutting quality.

The invention has the advantage that expensive and complex apparatuses of only limited usefulness, as are known from the prior art, can be avoided, while at the same time the advantages and improvements of the best of the prior cutting devices, as known from this applicant's EP 0 367 715, are maintained. A particular attribute of the present invention resides in making it possible to increase quality in high-performance cutting, where improvements in the edge retention of even a few percent are extremely important in terms of cost.

The apparatus according to the invention serves for trimming continuously conveyed printed products, or aligned printed-product groups located one above the other, which are conveyed by a plurality of conveying elements which run around a closed path. These conveying elements may be cells of a cutting drum, circulating gripper pockets or also grippers of a gripper chain. The printed products are moved, on their conveying path, past one or more cutting stations. In each cutting station, at least one edge of the printed product or of the printed-product group is trimmed with shear action by means of knives and counter-knives. Within the context of the invention, a plurality of self-sharpening knives come into cutting engagement with at least one counter-knife or a plurality of counter-knives come into cutting engagement with at least one self-sharpening knife. Of course, the printed products or printed-product groups have to be suitably clamped in order that they are stabilized during cutting engagement and shear cutting can take place precisely.

The self-sharpening is preferably achieved here in that, on that flank of the knife cutting edge which is directed toward the cutting plane, the knife or the knives has or have a coating or hardening in a peripheral zone, and this has a greater level of hardness than the body of the knife. It is advantageous here if the knife cutting edge has a bevel angle of less than 25°, preferably in the range of 15° to 20°.

A further preferred embodiment of the invention uses knives which have a second angled portion, which is adjacent to the bevel angle of the knife cutting edge and, with that flank of the knife which is directed toward the cutting plane, encloses an angle which is more acute than the respective bevel angle.

In a preferred configuration of the invention, at least two knives come into cutting engagement with a plurality of counter-knives or at least two counter-knives come into cutting engagement with a plurality of knives. For this purpose, the printed products can preferably be guided past a cutting station which contains a rotating knife cylinder, of which the plurality of knives in the cutting station each come into cutting engagement with a counter-knife.

A further improvement in the cutting quality and knife service life can be achieved by using means referred to here as correction parts, e.g. counter-strips which have undergone a specific tempering operation and come into contact, or into cutting engagement, with the knives, these correction parts being arranged intermittently between the plurality of counter-knife.

The method according to the invention is distinguished in that the self-sharpening knives and counter-knives are guided past one another exclusively in the same movement direction. Cutting engagement of the knives with counter-knives, intermittently with correction parts, is particularly advantageous here.

### BRIEF DESCRIPTION OF THE DRAWINGS

Exemplary embodiments of the invention will be explained in more detail with reference to the following figures, in which:

FIG. 1 shows a three-dimensional drawer of a conventional cutting drum;

FIG. 2 shows a three-dimensional drawer of a conventional cutting knife for head or foot trimming;

FIG. 3 shows an illustration of a knife according to the invention;

FIG. 4 shows a three-dimensional drawer of a cutting drum with a knife/counter-knife ratio of 2:40; and

FIG. 5 shows an illustration of a knife in the worn state.

### DETAILED DESCRIPTION OF THE INVENTION

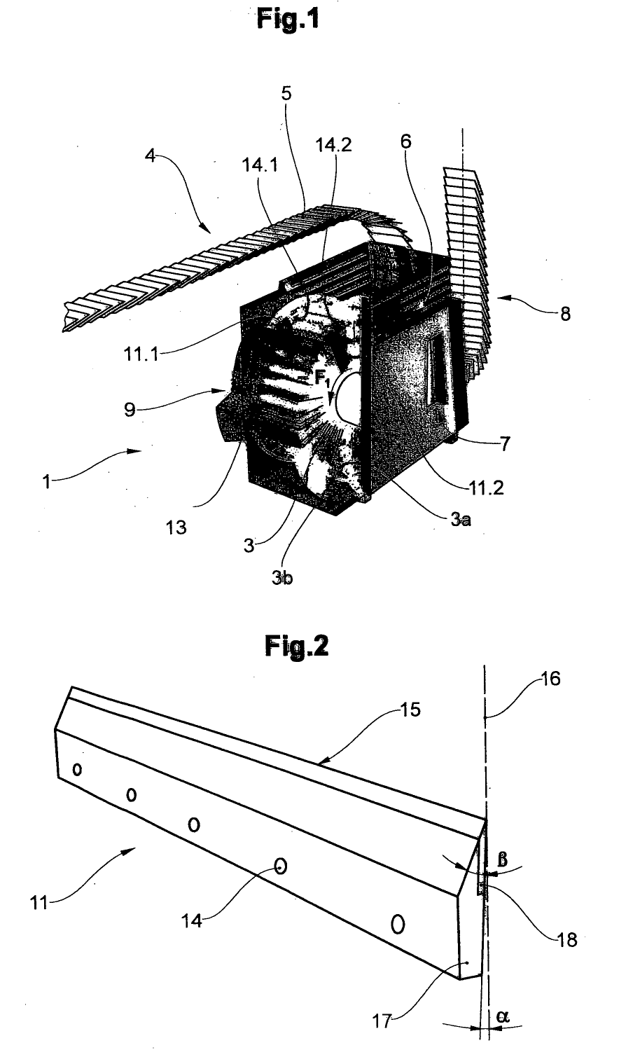

FIG. 1 shows a conventional cutting-drum machine 1 with a drum rotor 2 which has a plurality of cells 3 revolving around its periphery. Each cell has a leading and trailing cell wall 3a, 3b. A feed conveyor 4 transports printed products 5, in this case in the form of an imbricated stream (scaled stream), to the cutting-drum machine 1. The printed products 5 are separated and fed, in a transfer region 6, to the drum rotor 2, and therefore in each case one printed product 5 is introduced into each of the cells 3, which revolve in the direction of the arrow F₁. The drum rotor is driven by a drive 9 (not illustrated in any more detail here). Once the drum has revolved through approximately 300°, the printed products 5 are removed again from the drum rotor 2 at a removal location 7 and are fed here, once again in an imbricated formation, by a removal conveyor 8 to any other processing steps, such as insertion, stacking or bundling.

Two knives 11.1 and 11.2 are arranged, for the so-called head and foot trimming, to the sides of the drum rotor 2, as viewed from the side at an approximately 11 o'clock position. The two knives 11.1, 11.2 are at a slight angle in relation to a radial line of the drum rotor. A further knife 12 is oriented slightly obliquely in relation to the horizontal on the cylinder periphery of the drum rotor 2, as viewed from the side at an approximately 8 o'clock position. These knives 11.1, 11.2, 12 are in cutting engagement with counter- knives 13, 14.1, 14.2, which in the example shown are integrated in the edges of the trailing cell wall 3b. The essential factor is that for the actual cutting, or just before, the printed product and counter-knife are aligned precisely in relation to the cutting line, brought into well-defined abutment in relation to one another and clamped. This can be achieved, for example, by the abovementioned counter-knives 13, 14.1, 14.2 integrated in the cell wall 3b or by means of counter-knives which are briefly assigned to the printed products in the respective cutting region in each case and of which the movement path is provided in a suitable manner. Moreover, the cells have clamping means (not illustrated specifically). For the purpose of cutting thick printed products, the cutting stations may also be distributed over two or more cutting drums. For details in this respect, reference is made to EP 0 367 715.

FIG. 2 shows a conventional knife 11 which serves for trimming the head edge or foot edge of the printed product. The knife has an angled cutting edge 15 with a so-called bevel angle β. The knife is positioned at an angle of inclination α in relation to the cutting plane 16. This angle is typically 0° to 9° for cutting paper. In industrial apparatuses, the knife 11 comprises two parts, namely the knife body 17 and a soldered-in hard-metal cutting-edge element 18. For the knife body 17, use is usually made of a C45 steel composite material, and a hardened material of extremely high quality is used for the hard-metal cutting-edge element. For cutting paper, a person skilled in the art uses knives with a bevel angle of 25° to 85° for the upper knife and a bevel angle of 85° to 88° for the lower knife. The knife body 17, in addition, has a plurality of threaded bores 19 for the purpose of fastening the knife 11 on the knife holder (not illustrated here).

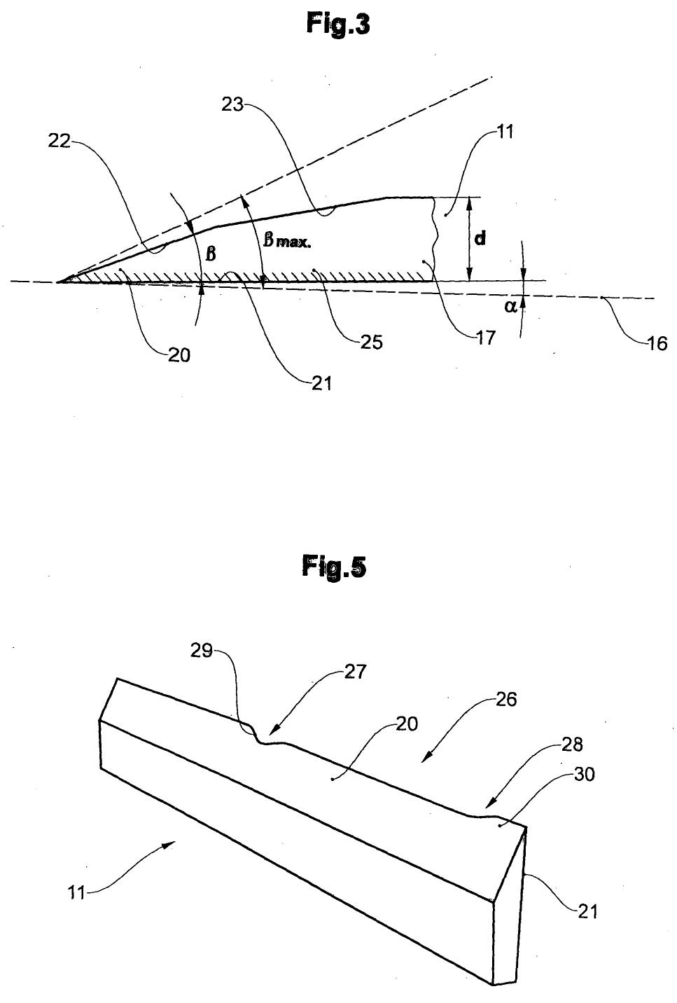

FIG. 3, then, shows a knife which is preferably used in the cutting method according to the invention. The drawer is illustrated schematically, with vertical exaggeration and enlargements, and is therefore not true to scale. The knife 11 is constructed in one piece, i.e. without any soldered-in hard-metal cutting-edge element, and has a bevel angle β of in this case approximately 20°. The angle of inclination α is approximately 2.5°. The invention provides for the bevel angle to be significantly below the bevel angles used hitherto for paper-cutting purposes, but in any case below the previous lower limit of 25°, which is indicated by the angle βₘₐₓ, which is preferably 15° to 20°. The fact that the knife is in one piece has advantages in terms of production and costs. A peripheral zone 25 of the knife cutting edge 20 is hardened on a flank 21, which is directed towards the cutting plane 16, and this is indicated by hatching. The hardening is preferably carried out so as to produce, in the direction of the basic body of the knife, a hardened-gradient profile such that the greatest level of hardness is on the outside of the flank, and then decreases slowly toward the basic body. The basic body of the knife itself has not been hardened (approximately 20 HRC). As a result, the knife 11 has a self-sharpening effect. As an alternative, it is also possible for a hard layer to be applied to the flank 21. Since the hard layer or the hardened knife-flank region has a low coefficient of friction, on account of the tribological parameters selected, the signs of wear can be directed virtually entirely to the beveled flank 22, which becomes pitted as a result. The hard layer or coating of the flank 21 thus forms, in a permanent basis, a sharp cutting edge. The arrangement of the peripheral zone 25, in addition, means that the pitting and knife wear do not result in the cutting clearance becoming enlarged.

The knife which is shown in FIG. 3 has, on its beveled flank 22, a second angled portion 23, of which the angle in relation to the flank 21 is more acute than the bevel angle β, in this case for example approximately 15°. This second angled portion 23 makes it possible, on the one hand, to provide for advantageous introduction of force into the knife body; on the other hand, the so-called clearance angle can be increased. It is particularly important, however, that this second angled portion 23 can keep the thickness d of the knife low and can influence the pitting of the flank 22, in which case it is still ensured that the bevel angle β, which is extremely important for the cutting quality and cutting forces, can be kept as constant as possible. Correspondingly, other measures may preferably be taken to produce defined locations of stress concentration, e.g. roughening or notching on the flank 22 of the knife cutting edge. A person skilled in the art is aware that this gives rise to a comparatively narrow knife cutting edge which, in use, has a largely constant bevel angle β.

The knife cutting edge 20 and the blade body 17 may thus be designed to be thinner according to the invention than in the prior art −7 to 15 mm is conventional in the prior art—and have a low thickness d. Particularly also on account of there being no hard-metal cutting-edge element, these usually being approximately 2 mm in thickness, the thickness d can be reduced substantially to preferably 5 to 6 mm. As has surprisingly been found, these measures give rise to blades which are referred to, within the context of this invention, as tolerant blades. Their thin construction, the single-piece nature combined with hardening of the flank 21 and the formation of an acute bevel angle, gives rise to an effect which can be referred to as a close-contact effect. The blade, in this way, allows slight bending and torsion tolerances. In comparison with conventional cutting knives, the cutting clearance can thus be further reduced to 10 micrometers (μm) or less, which, in turn, results in the cutting quality being improved. During cutting engagement, the cutting-engagement region (“cutting point”) moving along the knife cutting edge on account of the oblique positioning of the knife, the knife allows yielding movements in the microscopic range. This makes it possible to avoid, or vastly reduce, signs of wear and notch effects which would inevitably occur in the case of the abovementioned cutting-clearance tolerances of prior-art knives in the paper industry during high-performance cutting (>80,000 copies/hour with product thicknesses of >5 mm). Added to this is the fact that this close-contact effect combines with the self-sharpening effect of the blades, in which case a high level of edge retention results along with high cutting quality.

As far as high-performance cutting is concerned, the dynamics of the entire cutting process are extremely important. It should be mentioned here once more that dynamic processes in which the products are cut as they flow involve not just movement of the printed products, but also vibration of the machine parts. If only very small cutting-clearance dimensions are selected, as envisaged according to the invention, then even slight kinematic tolerance deviations may result in collision problems. Thermal influences, which may affect the precise knife position, are likewise crucial.

Within the context of the present invention, the printed products are separated prior to being trimmed, that is to say they are not cut in an imbricated stream (scaled stream) since the conditions involved in this case with overlapping printed products mean that it is not possible to achieve sufficient cutting quality. It should be pointed out that it is nevertheless possible, within the context of the invention, for the printed products also to be cut together in small groups of two or more products, provided these have been aligned in relation to one another in respect of the edge which is to be trimmed. The upper limit of the method and of the apparatus according to the invention is a total thickness which can still be cut by shear cutting. These limits nowadays are constituted by a total thickness of around approximately 10 to 20 mm. The shear-cutting principle is essential for the method used here.

As detailed tests and measurements have shown, the abovementioned close-contact effect is particularly advantageous, contrary to expectations, if, rather than one knife acting against a rigidly assigned counter-knife, there is a ratio of n:m between the knives and counter-knives, where n is a number greater than 1 and m is equal to or greater than 1. In other words, the invention uses cutting apparatuses which have, for example, a knife/counter-knife ratio of 1:4 (one knife and four counter-knives) or such a ratio of 2:40 (two knives and 40 counter-knives). As is known to a person skilled in the art, knives and counter-knives do not differ to begin with by material selection, but by their geometries, the bevel angle of the counter- knife (lower knife) differing to the extent where, for the printing industry, it is between 85° and 88°.

Within the context of the present invention, it is also possible to use counter-knives which, in a manner analogous to the knife, are hardened on just one flank (the flank directed toward the cutting plane) and may thus likewise have self-sharpening properties. It is also possible, within the context of the invention, to select the ratio n:m for knives and counter-knives such that there are more knives provided than counter-knives, that is to say, for example, a ratio of 16:1 or 36:3.

The new possibilities of knife/counter-knife ratios in which both n and m are greater than 1 should be discussed here in particular. In known cutting drums, one of these numbers was always equal to 1, that is to say either a plurality of counter-knives interacted with one knife or a plurality of knives interacted with one counter-knife.

If there is need for a further increase in the production speeds, as has been described in the introduction, the cutting-capacity requirements increase. If there is an increase in the cutting capacity in a cutting device which has just one knife per edge which is to be cut, it can immediately be seen that for example a 50% increase in the capacity necessarily leads directly to the knives being subjected to more loading in this order of magnitude. It is not just thermal loading which is in question here, but also quicker wear times, and these inevitably result in shorter times in use of the cutting apparatus, since the individual knife has to be maintained. It would theoretically be possible to provide solutions with parallel lines to two cutting apparatus, although this would involve doubling of the overall machine outlay, additional logistical outlay and thus significant increases in costs.

The above-described close-contact effect, in contrast, allows the use of systems with optimized knife/counter-knife ratios. FIG. 4 shows, schematically, a cutting drum with a drum rotor 2 which has forty cells 3.1, 3.2, 3.3 . . . 3.n revolving in the direction of the arrow F₁. Each cell wall is fitted with a counter-knife 14.1 . . . 14.n, fitted in a conventional manner with hard-metal knives (or, as an alternative to this, having self-sharpening counter-knives). Clamping means 24 are provided for clamping the printed sheets. The arrangement of the cell wall and clamping means 24 may also be in reverse, i.e. the cell wall with its counter-knives 14.1 . . . 14.n is then leading. In this case, the direction of rotation (arrow F₂) of a knife cylinder 31 (cf. next paragraph) should preferably be reversed, in which case the knives 11.1, 11.2 of this knife cylinder can be moved at greater speeds and cut the printed products as they catch up with them in each case.

In the present case, all three cell walls are fitted with counter-knives appropriate for head, foot and front trimming. FIG. 4 shows just a single cutting station 10 for the head trimming of printed-product groups 5′ (for example two aligned printed products located one above the other in each cell 3). Provided for this purpose is a rotating knife cylinder 31 which has two recesses 32.1, 32.2 on its lateral surface. The knife cylinder 31 revolves in the direction of the arrow F₂ about an axis a which runs essentially parallel to a radial line of the drum rotor 2. Each of the recesses here is provided with a knife 11.1, 11.2 on its trailing edge. The speed of rotation of the knife cylinder 31 is coordinated with the speed of revolution of the drum rotor 2 such that the printed-product groups 5′, which project laterally beyond the cell periphery, engage in these recesses 32.1, 32.2 and the knives 11.1 then come into cutting engagement in each case with the counter-knives 14.1 . . . 14.n. This makes it possible to reduce the requirements which have to be met by the cutting capacity of each of the knives 11.1, 11.2 and/or to increase the time in use of the knives and thus of the cutting apparatus as a whole. As a further alternative, it is possible for both knives and counter-knives to have dedicated, continuous movement paths, in which case the cells walls are not fitted with a counter-knife. For trimming with the knife, it has to be ensured that the counter-knives and printed products are brought into abutment along the cutting line and, of course, that suitable clamping takes place. In this case, knife/counter-knife ratios of, for example, 4:1 and 6:2 are preferable.

Although in this case an additional kinematic component, namely the revolution of the knives 11.1, 11.2, is added in relation to the known cutting drums, the close-contact effect of the knives according to the invention makes it possible to meet the requirements which have to be met by the cutting quality and, in particular, the cutting clearance which is necessary for this purpose. As has surprisingly been found, the self-sharpening effect is enhanced by a knife/counter-knife ratio of 1:m or n:m. Using tolerant knives means that the latter are not worn or damaged to a more pronounced extent by the cutting engagement with a plurality of counter-knives, as would be assumed; rather, an improving, grinding-like effect takes place.

The alternating forces between a knife and various counter-knives even results, as measurements have shown, in a kind of self-healing action. In other words, the self-sharpening knives, in particular when the latter are designed as tolerant knives, compensate for relatively small irregularities or notching by the forces bringing about a kind of secondary grinding of the knife during cutting engagement. It should be noted that the effect referred to here as “secondary grinding” is not so much an actual abrasive grinding of the knives, but rather plastic deformation, possibly in conjunction with minimal grinding effects. The secondary grinding is brought about by the paper and/or contact or “virtual contact” between knife and counter-knife. The virtual contact likewise has an influence on the self-healing action of the knives since the reduced distance between the knife and counter-knife results in the increased action of force between the two (with paper parts therebetween), and material compensation takes place on account of the possible material deformability of the knives and/or of the tolerance thereof. This effect is utilized, then, according to the invention, and provision is made for 1:1 knife /counter-knife ratios not be used in high-performance systems. This makes it possible for the edge retention to be significantly increased and for the cutting quality to be improved. Moreover, it has been found that the counter-knives can be configured in a conventional manner and used together with a self-sharpening knife, which comes into cutting engagement with the counter-knives.

The invention utilizes specifically moving counter-knives (or knives) which revolve continuously and are always guided past their counterpart (knife or counter-knife) in the same movement direction. The self-sharpening knife cutting edge is thus subjected to stressing preferably just in one direction, this contrasting for example with back and forth knives as are used, for example, in guillotine-like cutting apparatuses. It has been found that in this way, surprisingly, with knife/counter-knife ratios of 1:4 and above, knife cutting edges which are hardened only to a slight extent even on their flank which is directed towards the cutting plane have a self-sharpening and self-healing effect. A uniform movement of the knives in the same direction during the cutting operation is thus preferable for the invention. In particular embodiments, the above-described self-healing effect makes it possible to use even non-hardened counter-knives or knives.

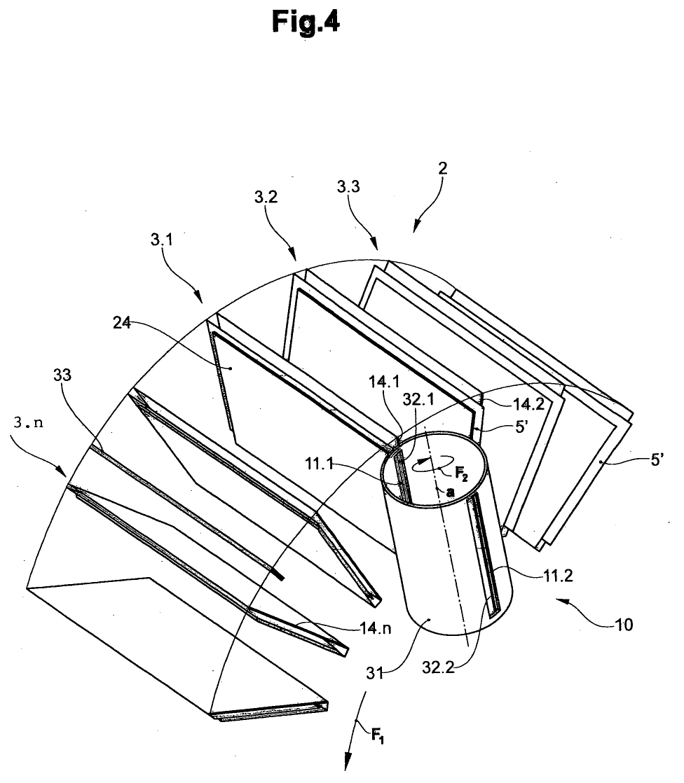

FIG. 5, then, shows a further problem which is disadvantageous for the knife service life and for which the present invention discloses a solution. On account of the oblique positioning, the knife 11 is struck at an engagement region 27 during each cut. In other words, the moving product (not illustrated here) strikes abruptly in each case against the knife 11 at the engagement region 27, in which case the knife is subjected to considerable forces at this location. Added to this is the fact that the printed products are usually moved such that the fold of the product is located precisely in this engagement region, this fold obviously being stiffer than the rest of the printed product and, in addition, often being adhesively bonded, which necessitates an even higher cutting force. It is also possible for adhesive residues to get stuck in the engagement region and thus to result in increased knife wear.

During the subsequent shear cutting, the cutting region then moves from the engagement region 27 to a cut-off region 28, that is to say from left to right in FIG. 5. As a result, following a relatively long period of use, the knife 11, in the worn state, shows signs of wear on the knife cutting edge 20. Notching 29 occurs in the engagement region and an elevation 30 is produced in the cut-off region 28, these being attributable to the fact that the width of the printed products which are to be cut, and thus the loading to which the knife cutting edge is subjected, is located only between the engagement and cut-off regions, and thus where the actual cutting region 26 is located. Both effects, i.e. the notching 29 and the elevation 30, are very disadvantageous for the cutting quality.

The invention, then, makes provision to prevent these effects in that the hardening along the flank 21, which is located in the vicinity of the cutting plane 16 (see FIG. 3), is effected not uniformly along the knife cutting edge, but in dependence on a non-linear function. This is determined such that the level of knife hardening is greater in the engagement region 27 than in the cutting region 26 and in the cut-off region 28, different degrees of hardness preferably also being provided for the cutting region 26 and cut-off region 28. Ideally, the non-linearity of the hardening along the knife cutting edge 20 and the wear function thereof as a result of the active cutting forces and of further parameters (folding location, hardness of the adhesive bonding on the fold, heat dissipation of the blade, etc.) offset one another. As a result, the above-described notching effects and elevations can be vastly reduced or avoided altogether. A person skilled in the art is aware that the precise position for different levels of hardening along the knife cutting edge 20 can depend on the various types of product to be cut. It is always possible to utilize empirical values of wear regions and thus produce a wear profile. It is preferable for the degree of hardness which is used for the hardening of the knife cutting edge to be determined directly linearly in dependence on this wear profile squared or cubed—accordingly, the different degrees of hardness along the knife cutting edge 20 are determined in functional dependence on the wear profile of a non-hardened knife 11. The non-hardened knife here is to be measured, following a relatively long period of sustained operation, at the location which is intended for the self-sharpening knife. If the cutting edge of a non-hardened knife (C45 quality) is worn for example at a certain location by 0.1 mm and at the engagement location by 0.3 mm, then the ratio of these two wear factors determines the wear profile and this, in turn, determines the degree of hardness which is to be selected for the corresponding region of the knife cutting edge.

A further advantage of the invention resides in the fact that, in the case of the comparatively thin knives (cf. what is said above in relation to FIG. 3), the knives can be assigned a certain amount of torsion by shaping of the knife holders. It is thus possible for the knife cutting edge to be curved so as to approximate a helix, an ellipsoid or the like.

It is thus possible to achieve extremely high cutting qualities even for the front trimming since there, as is described in more detail in EP 0 367 715, it is not usually possible for the knives to be of linear configuration on account of their oblique positioning in relation to the counter-knife for the purpose of achieving shear cutting; rather, they have to have precisely one of the abovementioned three-dimensional or planar curved configurations. Here too, according to the invention, use is made of the close-contact effect of the knives in conjunction with the self-sharpening and self-healing actions thereof. It is thus possible, even with such complex cutting ratios and/or geometries, to achieve long service lives and an excellent cutting quality.

In the case of particular embodiments, instead of a flank of the knife cutting edge being hardened, it is also possible to apply a thin layer or coating, in which case a hard surface coating is formed in certain regions of the corresponding knife flank. Particularly suitable coatings are ones which have a hardness gradient running from the outside in the direction of the knife serving as a substrate body, in which case use can be made of the bionic self-sharpening, which is known for example from DE 10 2004 052 682, as a result of this asymmetric coating with its hardness gradient. Extensive measurements and tests have shown that, as far as trimming paper is concerned, a layer thickness of 10 to 30 μm gives rise to optimum cutting qualities. A galvanically applied hard layer or a ceramic outer layer of a few μm in thickness applied to the knife body over a connecting layer likewise give rise to good cutting qualities for printed products.

For hardening of the knife, a hardness gradient to a depth of 20 to 25 μm is provided in the proximal direction of the knife basic body, optimum results being achieved by the invention at 8 to 20 μm. The critical factor both for the close-contact effect and for the self-sharpening effect is a pronounced difference in hardness between the hard layer and knife body or substrate.

It is also particularly advantageous to have comparatively thin hard layers/levels of hardening of 5 to 12 μm in conjunction with hardnesses of 1500 to 2000 HV.

For application areas where certain regions of the knife cutting edge are subjected to particularly pronounced forces acting thereon, for example in the case of cutting products with particularly thick and stiff folding edges, it is possible to provide hard-metal inserts in certain regions of the knife. In these regions, however, the advantages according to the invention are no longer present. The concept of the invention is not forsaken in view of the effects in the rest of the regions of the knife.

In order for the self-healing effect which is achieved by means of the in particular tolerant knife according to the invention to be increased yet further, it is preferably possible for correction means to be provided (illustrated schematically as 33 in FIG. 4) intermittently in relation to the counter-knives (or knives), these correction means promoting self-healing and/or self-sharpening. For this purpose, it is possible to provide, for example, a highly precise correction means, such as a counterpart which is ground, hardened or provided with a grinding surface or else a special hardened and tempered counter-knife, which is guided up to the respective knife possibly up to a distance of just 2 to 5 μm. The correction means is not necessarily brought into cutting engagement with the knife together with the printed products which are to be cut, but it has a surface structure such that small knife errors can be corrected in a grinding-like manner. If appropriate, the correction part, provided the latter is fitted, for example, on a particular cell of the drum body, may be assigned special adjusting elements (e.g. thin products or surface-treated parts) at regular or special intervals which give rise to cutting engagement between the correction part and knives and thus promote the healing of knife damage. It is possible here for the correction parts, if required, to bring about an actual grinding action. In this way, it is also possible to use a number of straightforwardly hardened, and thus cost-effective, counter-knives together with individual counter-knives which have been exposed to a high level of hardening and tempering, e.g. which have a self-sharpening effect. It is also possible in this way for the self-sharpening and self-healing effects to be achieved using just a small number of high-quality counter-knives.

The cutting method according to the invention is based on a plurality of counter-knives being guided in the same direction past a self-sharpening knife (or vice versa). The trimming of various edges of the printed product takes place in a plurality of cutting stations, it being possible for head and foot trimming to take place essentially at the same location of the movement path of the printed products.

A person skilled in the art is aware that the invention of course is not restricted to cutting apparatuses with drum bodies or revolving cells or pockets or grippers. The concept of the invention likewise relates to other cutting apparatuses, in particular in the context of high-performance cutting edges, using grippers, cells, etc., which are moved along a non-rotary movement path and give rise to continuously conveyed printed products being cut with shear action according to the invention.

1. A cutting apparatus for trimming continuously conveyed printed products (5) comprising:
a plurality of conveying elements (3) which run around a closed path for conveying at least one separated printed product (5) or printed-product groups (5′), wherein the printed products (5, 5′) are moved, along their conveying path, past at least one cutting station (10), where at least one edge of the printed product (5) is trimmed with shear action by means of knives (11, 12) and counter-knives (13, 14), wherein one or more self-sharpening knives (11, 12) come into cutting engagement with one or more counter-knives (13, 14).

2. The cutting apparatus of claim 1, wherein on the flank (21) of the knife cutting edge (20), this flank being directed towards the cutting plane (16), the one or more knives (11, 12) have a coating or hardening in a peripheral zone (25) with a greater level of hardness than the body (17) of the knife (11).

3. The cutting apparatus of claim 1 wherein one or more knives (11, 12) have a cutting edge (20) with a bevel angle (β) of less than 25°, preferably in the range of 15° to 20°.

4. The cutting apparatus as claimed in claim 1 wherein the knife cutting edge (20) has a second angled portion, which is adjacent to the bevel angle (β) and with the flank (21) of the knife (11, 12), this flank being directed towards the cutting plane (16), encloses an angle which is more acute than the bevel angle (β).

5. The cutting apparatus as claimed in claim 1 wherein at least two knives (11, 12) come into cutting engagement with a plurality of counter-knives (13, 14).

6. The cutting apparatus as claimed in claim 1 wherein at least two counter-knives (13, 14) come into cutting engagement with a plurality of knives (11, 12).

7. The cutting apparatus as claimed in claim 5 wherein at least one cutting station (10) of the apparatus contains a rotating blade cylinder (31), of which the knives (11) each come into cutting engagement with a counter-knife (13, 14).

8. The cutting apparatus as claimed in claim 1 wherein the one or more knives (11, 12) come into contact, virtual contact or into cutting engagement with correction parts (33) which are arranged intermittently between the one or more counter-knives (13, 14).

9. The cutting apparatus as claimed in claim 1 wherein the knife (11, 12), along its cutting edge (20), has different degrees of hardness in functional dependence on the wear profile of a non-hardened knife (11, 12).

10. A cutting method for trimming continuously conveyed printed products (5) comprising:
a plurality of conveying elements (3) which run around a closed path for conveying at least one separated printed product (5) or printed-product groups (5′), wherein the printed products (5) are moved, along their conveying path, past at least one cutting station (10), where at least one edge of the printed product (5) is trimmed with shear action by means of knives (11, 12) and counter-knives (13, 14), wherein self-sharpening knives (11, 12) and counter-knives (13, 14) are guided past one another exclusively in the same movement direction.

11. The cutting method as claimed in patent claim 10, wherein one or more knives (11, 12) are brought into cutting engagement intermittently with counter-knives (13, 14) and correction parts (33).
